(19) United States
(12) Patent Application Publication
(10) Pub. No.: US 2018/0276924 A1
(43) Pub. Date: Sep. 27, 2018

(54) VEHICLE-MOUNTED DEVICE, PORTABLE DEVICE, AND VEHICLE WIRELESS COMMUNICATION SYSTEM

(71) Applicant: Panasonic Intellectual Property Management Co., Ltd., Osaka (JP)

(72) Inventor: NAOKI HAYASHI, Kanagawa (JP)

(21) Appl. No.: 15/991,756

(22) Filed: May 29, 2018

Related U.S. Application Data
(63) Continuation of application No. PCT/JP2016/005077, filed on Dec. 7, 2016.

(30) Foreign Application Priority Data
Dec. 10, 2015 (JP) 2015-241438

(51) Int. Cl. G07C 9/00; B60R 25/24; G08C 25/02

(52) U.S. Cl. CPC G07C 9/00309; B60R 25/24; G08C 25/02; G07C 2009/00396; G07C 2009/00555; G07C 2209/63; G07C 9/00111

(57) ABSTRACT

An LF transmitter of a vehicle-mounted device sends a request signal, and first and second measurement signals to a portable device. The LF transmitter sends to the portable device the second measurement signal with a transmission intensity different from that of the first measurement signal. An UHF receiver of the vehicle-mounted device receives, from the portable device, a response signal containing information on reception intensities of the first and second measurement signals. The vehicle-mounted device authenticates the portable device based on a relation between the information on the reception intensity of the first measurement signal and the information on the reception intensity of the second measurement signal contained in the response signal received by the UHF receiver and a relation between the transmission intensity of the first measurement signal and the transmission intensity of the second measurement signal sent from the LF transmitter.

### CROSS-REFERENCE TO RELATED APPLICATIONS

This application is a continuation of the PCT International Application No. PCT/JP2016/005077 filed on Dec. 7, 2016, which claims the benefit of foreign priority of Japanese patent application No. 2015-241438 filed on Dec. 10, 2015, the contents all of which are incorporated herein by reference.

### BACKGROUND

### 1. Technical Field

The present disclosure relates to a communication technology, and more particularly to a vehicle-mounted device installed in a vehicle, a portable device of a user, and a vehicle wireless communication system that establishes communication between the vehicle-mounted device and the portable device.

### 2. Description of the Related Art

Electronic key systems include a key operation free system that does not require button operations for an electronic key. In this system, a communication area of requests in LF (Low Frequency) band is formed around the vehicle. When an electronic key enters this communication area and accepts a request, the electronic key returns a response in RF (Radio Frequency) band to the vehicle. A relay attack is one of unauthorized uses of the key operation free system. In the relay attack, a third party with malicious intentions uses a repeater that can relay both requests from the vehicle and responses from the electronic key. Communication between the two parties thus become feasible even though the electronic key is not present in the vehicle communication area. To prevent relay attacks, a signal intensity pattern between the vehicle and electronic key is specified and the signal intensity pattern is collated (e.g., Japanese Patent Unexamined Publication No. 2011-52506).

### SUMMARY

A vehicle-mounted device in an aspect of the present disclosure includes a transmitter and a receiver. The transmitter is configured to send a request signal, a first measurement signal, and a second measurement signal to a portable device. The receiver is configured to receive a response signal from the portable device having received the request signal, the first measurement signal, and the second measurement signal. The response signal contains information on a reception intensity of the first measurement signal and information on a reception intensity of the second measurement signal. The transmitter sends to the portable device the second measurement signal with a transmission intensity different from a transmission intensity of the first measurement signal. The portable device is authenticated based on a relation between the information on the reception intensity of the first measurement signal and the information on the reception intensity of the second measurement signal contained in the response signal received by the receiver and a relation between the transmission intensity of the first measurement signal and the transmission intensity of the second measurement signal sent from the transmitter.

Another aspect of the present disclosure is a portable device. This portable device includes a receiver, a measurement unit and a transmitter. The receiver is configured to receive a request signal, a first measurement signal, and a second measurement signal from a vehicle-mounted device. The measurement unit is configured to measure a reception intensity of the first measurement signal and a reception intensity of the second measurement signal when the receiver receives the request signal, the first measurement signal, and the second measurement signal. The transmitter is configured to send, to the vehicle-mounted device, information on the reception intensity of the first measurement signal and information on the reception intensity of the second measurement signal measured by the measurement unit. The second measurement signal received by the receiver is sent from the vehicle-mounted device with a transmission intensity different from the transmission intensity of the first measurement signal. The vehicle-mounted device makes authentication based on a relation between the information on the reception intensity of the first measurement signal and the information on the reception intensity of the second measurement signal contained in the response signal sent from the transmitter and a relation between the transmission intensity of the first measurement signal and the transmission intensity of the second measurement signal received by the receiver.

Still another aspect of the present disclosure is a vehicle wireless communication system. This vehicle wireless communication system includes a vehicle-mounted device and a portable device. The vehicle-mounted device is configured to send a request signal, a first measurement signal, and a second measurement signal. The portable device is configured to measure a reception intensity of the first measurement signal and a reception intensity of the second measurement signal upon receiving the request signal, the first measurement signal, and the second measurement signal from the vehicle-mounted device, and send to the vehicle-mounted device a response signal containing information on the measured reception intensity of the first measurement signal and information on the measured reception intensity of the second measurement signal. The vehicle-mounted device sends to the portable device the second measurement signal with a transmission intensity different from a transmission intensity of the first measurement signal. The vehicle-mounted device authenticates the portable device based on a relation between the information on the reception intensity of the first measurement signal and the information on the reception intensity of the second measurement signal contained in the received response signal and a relation between the transmission intensity of the sent first measurement signal and the transmission intensity of the sent second measurement signal.

Any combination of the above components, any conversion of the present disclosure to a method, device, system, recording medium, a computer program, and so on are also valid as aspects of the present disclosure.

The present disclosure can reduce risks of relay attack on door-lock release.

### BRIEF DESCRIPTION OF DRAWINGS

FIG. 1A is a diagram showing a configuration of a vehicle wireless communication system related to Comparative Example in an exemplary embodiment of the present disclosure.

FIG. 1B is another diagram showing a configuration of a vehicle wireless communication system related to Comparative Example in the exemplary embodiment of the present disclosure.

FIG. 2A shows signals used in the vehicle wireless communication system in FIG. 1B.

FIG. 2B shows signals used in the vehicle wireless communication system in FIG. 1B.

FIG. 2C shows signals used in the vehicle wireless communication system in FIG. 1B.

FIG. 2D shows signals used in the vehicle wireless communication system in FIG. 1B.

FIG. 3 is a diagram showing a configuration of a vehicle wireless communication system in accordance with the exemplary embodiment of the present disclosure.

FIG. 4 shows signals used in the vehicle wireless communication system in FIG. 3.

FIG. 5 is another chart showing signals used in the vehicle wireless communication system in FIG. 3.

FIG. 6 illustrates characteristics of a RSSI circuit of a measurement unit shown in FIG. 3.

FIG. 7 still another chart showing signals used in the vehicle wireless communication system shown in FIG. 3.

FIG. 8 is a flow chart illustrating communication procedures of the vehicle-mounted device shown in FIG. 3.

FIG. 9 is a flow chart illustrating communication procedures of the portable device shown in FIG. 3.

### DETAILED DESCRIPTION OF PREFERRED EMBODIMENTS

Prior to describing an exemplary embodiment of the present disclosure, a disadvantage of the prior art is briefly described. A signal intensity pattern specified between a vehicle and an electronic key is formed by combining a signal not smaller than a threshold and a signal smaller than the threshold. Therefore, once the signal intensity pattern and threshold are identified, the signal intensity pattern can be easily reproduced, resulting in an easy relay attack.

The present disclosure is developed under the circumstances, and its object is to offer a technology to reduce risks of relay attacks on door-lock release.

An outline is given before specifically describing the exemplary embodiment of the present disclosure. The exemplary embodiment of the present disclosure relates to a vehicle wireless communication system for executing communication between a vehicle-mounted device installed in the vehicle and a portable device (electronic key) possessed by a user, so as to release a door lock of the vehicle. As described above, the exemplary embodiment aims to reduce risks of relay attacks on door-lock release. The vehicle-mounted device sends a request signal, and then two measurement signals (hereinafter, a preceding signal is called a “first measurement signal,” and a subsequent signal is called a “second measurement signal). A transmission intensity of the second measurement signal is set to be different from a transmission intensity of the first measurement signal. The portable device wakes up when receiving the request signal, and measures a reception intensity of the first measurement signal. Then, the portable device measures a signal intensity of the second measurement signal. The portable device puts information on measured reception intensity of the first measurement signal and information on measured reception intensity of the second measurement signal into a response signal, and sends the response signal to the vehicle-mounted device.

The vehicle-mounted device receives the response signal, and then extracts the information on the reception intensity of the first measurement signal and the information on the reception intensity of the second measurement signal contained in the response signal. The vehicle-mounted device identifies a relation between the reception intensity of the first measurement signal and the reception intensity of the second measurement signal, such as ½-fold and 2-fold. The vehicle-mounted device also identifies a transmission intensity of the first measurement signal and a transmission intensity of the second measurement signal. Furthermore, the vehicle-mounted device compares the reception intensity relation and the transmission intensity relation. When both relations match, as a result of comparison, the vehicle-mounted device releases the door lock of the vehicle. The information on the transmission intensity of the first measurement signal and the information on the transmission intensity of the second measurement signal are used only for internal processing in the vehicle-mounted device without transmitting these pieces of information from the vehicle-mounted device to the portable device. Accordingly, a risk of identification of the intensities reduces. In addition, since measured reception intensities are used for determination, reproduction is difficult. This also reduces a risk of relay attack. Although a detailed description is omitted in the exemplary embodiment, the vehicle-mounted device may also automatically open the unlocked door after releasing the door lock.

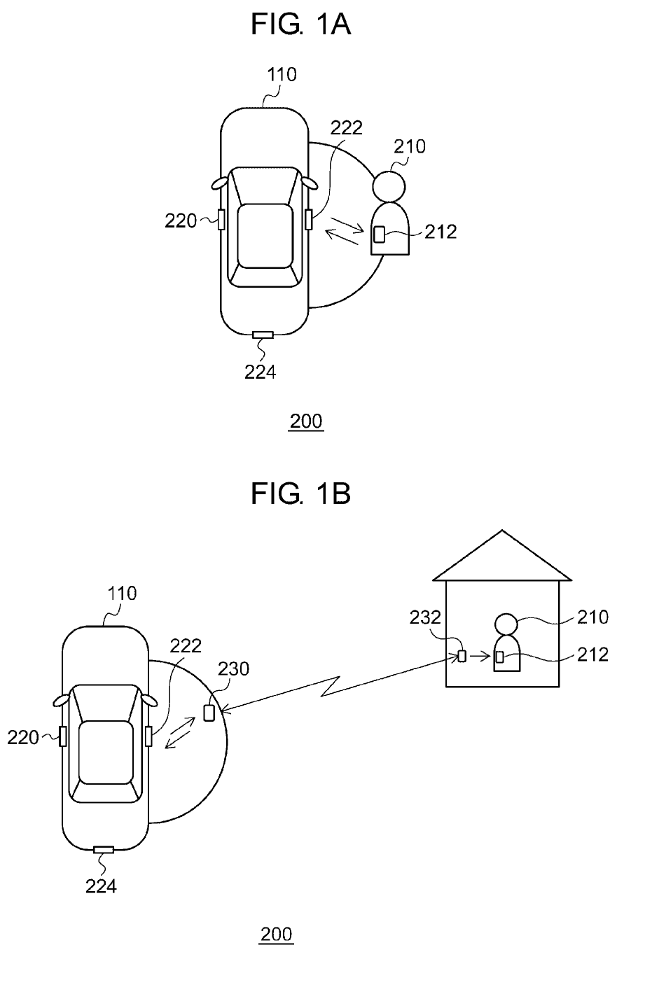

FIG. 1A and FIG. 1B show configurations of vehicle wireless communication system 200 related to Comparison Example in the exemplary embodiment of the present disclosure. FIG. 1A illustrates a normal lock-releasing operation by vehicle wireless communication system 200. In vehicle-wireless communication system 200, vehicle 110 is equipped with left-side antenna 220, right-side antenna 222, and rear antenna 224; and user 210 has portable device 212. Left-side antenna 220, right-side antenna 222, and rear antenna 224 are connected to the vehicle-mounted device installed in vehicle 110. Left-side antenna 220, right-side antenna 222, and rear antenna 224 send an LF signal, such as 125-kHz signal, and portable device 212 receives the LF signal. Portable device 212 sends a UHF (Ultra High Frequency) signal, such as 300-MHz signal, and left-side antenna 220, right-side antenna 222, and rear antenna 224 receive the UHF signal.

Vehicle wireless communication system 200 supports the aforementioned key operation free system. The key operation free system is also called the smart entry system, smart key system, and passive keyless entry system (PKE). In each of these systems, portable device 212 receives the LF signal from the vehicle-mounted device installed in vehicle 110, and returns the UHF signal if the LF signal is from a proper vehicle-mounted device. In this way, portable device 212 automatically responds and releases the door lock of vehicle 110. The LF signal and UHF signal are encrypted, and data in these signals is difficult to be identified. Still more, a communication distance of the LF signal sent from the vehicle-mounted device is limited to an area of about 2 m from vehicle 110, and thus portable device 212 far away from vehicle 110 does not erroneously respond to the LF signal.

FIG. 1B shows the operation when a relay attack is being performed on vehicle wireless communication system 200. For a relay attack, first repeater 230 and second repeater 232 are disposed between left-side antenna 220, right-side antenna 222, and rear antenna 224, and portable device 212. A third party, other than user 210 who owns vehicle 110, provides first repeater 230 and second repeater 232. In the relay attack, first repeater 230 and second repeater 232 relay the signals between the vehicle-mounted device and portable device 212, and the door lock of vehicle 110 is released regardless of the intention of user 210.

First repeater 230 receives the LF signals sent from left-side antenna 220, right-side antenna 222, and rear antenna 224, and converts them to the UHF signals. Second repeater 232 receives the UHF signals from first repeater 230, and converts the UHF signals into LF signals. Portable device 212 receives the LF signals from second repeater 232. In general, an LF signal has a short communication distance, and thus an LF signal is converted to a UHF signal that has longer communication distance between first repeater 230 and second repeater 232.

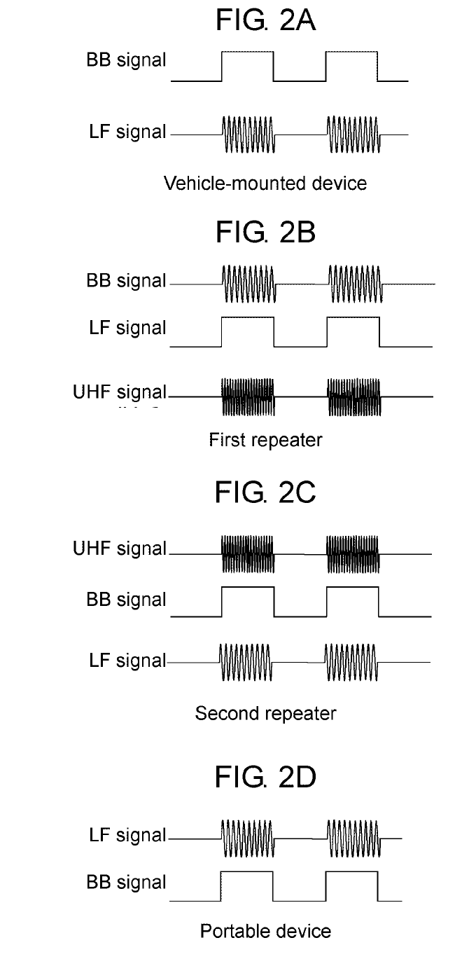

Signals in this case are detailed with reference to FIG. 2A to FIG. 2D. FIG. 2A to FIG. 2D show signals used in vehicle wireless communication system 200 in FIG. 1B. More specifically, FIG. 2A shows signals in the vehicle-mounted device, FIG. 2B shows signals in first repeater 230, and FIG. 2C shows signals in second repeater 232, and FIG. 2D shows signals in portable device 212. An upper part of FIG. 2A shows a baseband signal (BB signal) generated in the vehicle-mounted device, and a lower part of FIG. 2A shows an LF signal modulated based on the baseband signal in the vehicle-mounted device. The LF signal is sent from left-side antenna 220, right-side antenna 222, and rear antenna 22.

An upper part of FIG. 2B shows the LF signal received by first repeater 230. A middle part of FIG. 2B shows the baseband signal obtained by demodulating the LF signal in first repeater 230. A lower part of FIG. 2B shows the UHF signal modulated based on the baseband signal in first repeater 230. The UHF signal is sent from first repeater 230. An upper part of FIG. 2C shows the UHF signal received by second repeater 232. A middle part of FIG. 2C shows the baseband signal obtained by demodulating the UHF signal. A lower part of FIG. 2C shows the LF signal modulated based on the baseband signal in second repeater 232. The LF signal is sent from second repeater 232. An upper part of FIG. 2D shows the LF signal received by portable device 212. A lower part of FIG. 2D shows the baseband signal obtained by demodulating the LF signal. The system is described below with reference to FIG. 1B again.

The UHF signal from portable device 212 may be received by left-side antenna 220, right-side antenna 222, and rear antenna via second repeater 232 and first repeater 230, or received directly without being relayed. In this way, the vehicle-mounted device and portable device 212 execute processing same as that shown in FIG. 1A just by providing first repeater 230 and second repeater 232 between vehicle-mounted device and portable device 212. Accordingly, vehicle 110 can be unlocked without decryption at first repeater 230 and second repeater 232.

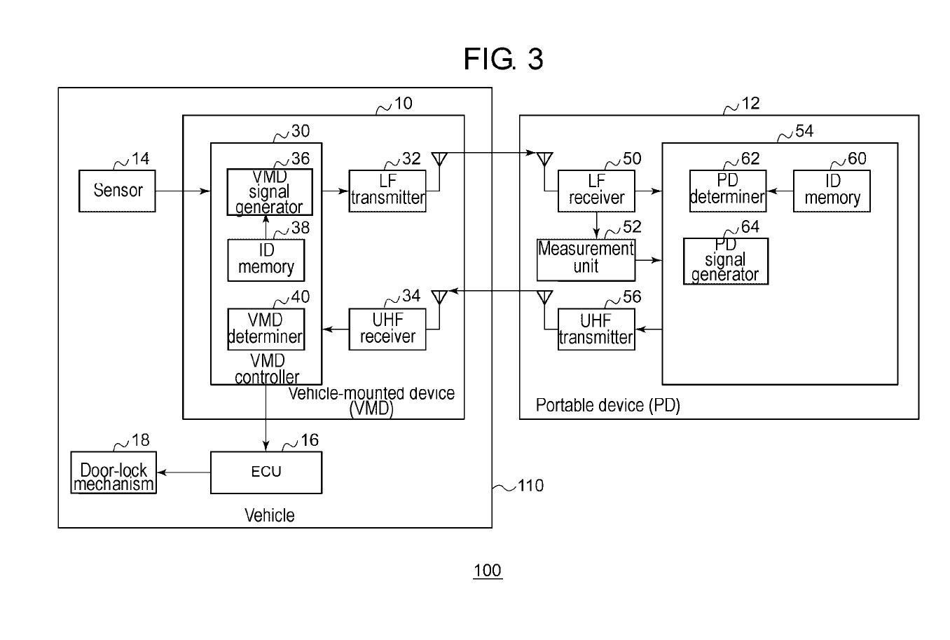

FIG. 3 shows a configuration of vehicle wireless communication system 100 according to the exemplary embodiment of the present disclosure. Vehicle wireless communication system 100 includes vehicle 110 and portable device 12. Vehicle 110 includes vehicle-mounted device 10, sensor 14, ECU (electronic control unit) 16, and door-lock mechanism 18. Vehicle-mounted device 10 includes vehicle-mounted device controller 30, LF transmitter 32 and UHF receiver 34. Vehicle-mounted device controller 30 includes vehicle-mounted device signal generator 36, ID memory 38, and vehicle-mounted device determiner 40. Portable device 12 includes LF receiver 50, measurement unit 52, portable device controller 54, and UHF transmitter 56. Portable device controller 54 includes ID memory 60, portable device determiner 62, and portable device signal generator 64.

Sensor 14 of vehicle 110 is provided typically on a door knob of vehicle 110, and detects a fact that the user touches the door knob. Sensor 14 adopts a known technology, and thus its description is omitted here. Upon detecting a touch, sensor 14 notifies the detection to vehicle-mounted device controller 30.

Vehicle-mounted device controller 30 of vehicle-mounted device 10 receives a notice from sensor 14, and then gives an instruction to vehicle-mounted device signal generator 36 to generate a signal. Upon receiving the instruction from vehicle-mounted device controller 30, vehicle-mounted device signal generator 36 extracts an ID stored in ID memory 34 and generates a request signal containing the ID. This ID is identification information used for authentication by pairing with portable device 12. The ID may be encrypted before being included in the request signal. The request signal generated by vehicle-mounted device signal generator 36 is a baseband signal. Vehicle-mounted device signal generator 36 outputs the request signal to LF transmitter 32.

Upon receiving the request signal from vehicle-mounted device signal generator 36, LF transmitter 32 modulates the request signal to generate a request signal of the LF signal (hereinafter, this is also called “request signal”). LF transmitter 32 sends the request signal to portable device 12 via an antenna. The antenna connected to LF transmitter 32 and an antenna connected to UHF receiver 34, which is described later, are disposed like left-side antenna 220, right-side antenna 222, and rear antenna 224 shown in FIG. 1A and FIG. 1B.

LF transmitter 32 sends a first measurement signal and a second measurement signal to portable device 12 after sending the request signal. The first measurement signal and the second measurement signal are signals for making portable device 12 measure reception intensities, and they are LF signals. In particular, the second measurement signal is set, in vehicle-mounted device controller 30, to have a transmission intensity different from a transmission intensity of the first measurement signal. The different transmission intensity may be a high transmission intensity or a low transmission intensity. Still more, a relation between the transmission intensity of the first measurement signal and the transmission intensity of the second measurement signal may be changed for every transmission.

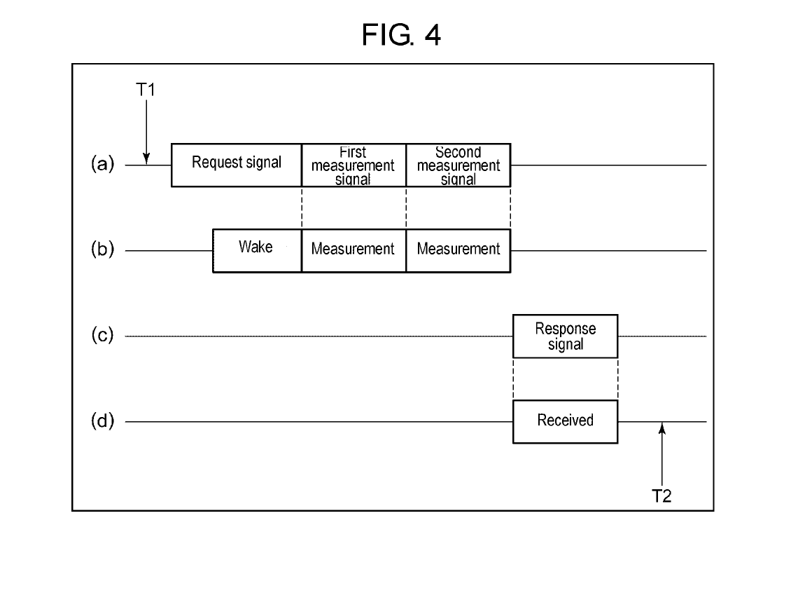

FIG. 4 shows signals used in vehicle wireless communication system 100. In particular, in (a) of FIG. 4 the LF signal sent from LF transmitter 32 of vehicle-mounted device 10 is illustrated. Upon receiving a notice from sensor 14 at timing T1, vehicle-mounted device 10 sends the request signal, the first measurement signal, and the second measurement signal successively. Others are described later.

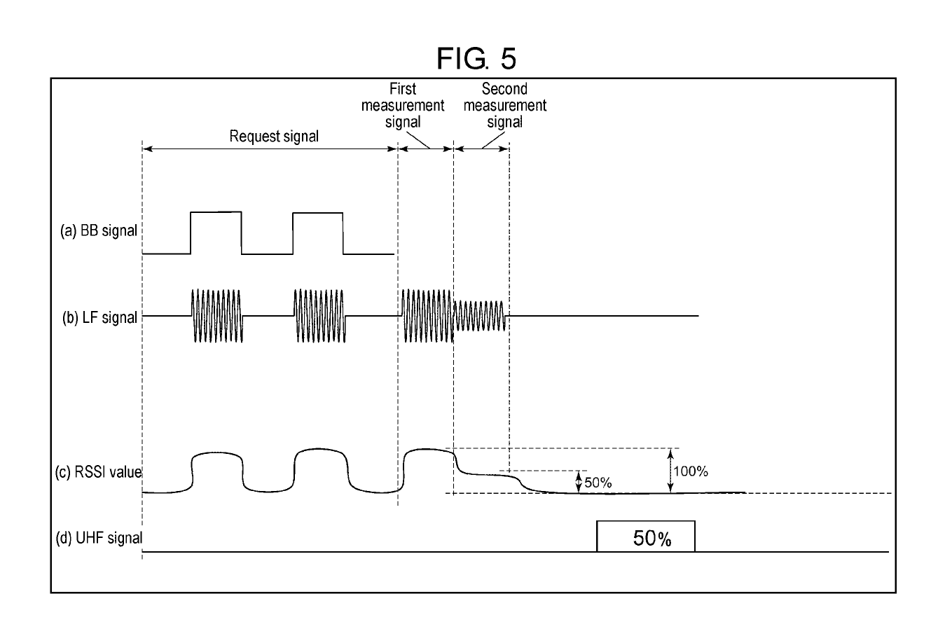

FIG. 5 is another chart showing signals used in vehicle wireless communication system 100. In (a) of FIG. 5, the request signal generated by vehicle-mounted device signal generator 36 is illustrated, and the request signal is the baseband signal, as illustrated. In (b) of FIG. 5, the LF signal sent from LF transmitter 32 is illustrated. As illustrated, the first measurement signal and the second measurement signal are sent, following the request signal that is modulated into an LF signal. Here, the transmission intensity of the second measurement signal is set to 50% of the transmission intensity of the first measurement signal. Others are described later. Description below continues with reference to FIG. 3.

LF receiver 50 of portable device 12 receives the request signal from vehicle-mounted device 10, and also receives the first measurement signal and the second measurement signal from vehicle-mounted device 10. LF receiver 50 demodulates the received request signal, and generates a request signal of the baseband signal (hereinafter, this is also called “request signal”). LF receiver 50 outputs the request signal to portable device controller 54. Upon receiving the request signal from LF receiver 50, portable device controller 54 wakes portable device 12 up.

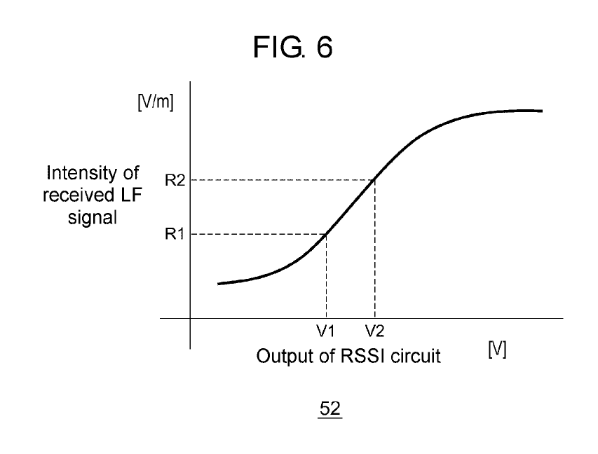

Subsequently, LF receiver 50 outputs the received first and second measurement signals to measurement unit 52. Measurement unit 52 measures a reception intensity of the first measurement signal, such as RSSI (Received Signal Strength Indicator). Measurement unit 52 also measures a reception intensity of the second measurement signal. FIG. 6 shows characteristics of a RSSI circuit included in measurement unit 52. As illustrated, the intensity (electrical field intensity [V/m]) of the received LF signal is associated with an output (voltage [V]) of the RSSI circuit. For example, when the intensity of the received LF signal is R1, the RSSI circuit outputs V1, and when the intensity of the received LF signal is R2, the RSSI circuit outputs V2. Back to FIG. 3, measurement unit 52 outputs a measured reception intensities to portable device controller 54.

In (b) of FIG. 4, processing of the LF signal received by LF receiver 50 of portable device 12 is illustrated. Wakeup is executed in response to the request signal, and the first measurement signal is measured in response to the first measurement signal. Then, the second measurement signal is measured in response to the second measurement signal. In (c) of FIG. 5, a measurement result obtained by measurement unit 52 of portable device 12 is illustrated. As illustrated, the reception intensity is increased in response to parts of the request signal and the first measurement signal. The reception intensity of 50% of the reception intensity in response to the first measurement signal is measured in response to the second measurement signal. Description below continues with reference to FIG. 3 again.

In portable device controller 54, portable device determiner 62 extracts an ID contained in the request signal. Still more, portable device determiner 62 obtains an ID stored in ID memory 60. Furthermore, portable device determiner 62 executes pairing authentication based on the extracted ID and the obtained ID. Pairing authentication adopts a known technology, and thus its description is omitted here. When pairing authentication fails, subsequent processing is not executed. On the other hand, when pairing authentication is successful, subsequent processing is executed.

Portable device signal generator 64 receives the reception intensity of the first measurement signal and the reception intensity of the second measurement signal from measurement unit 52. Portable device signal generator 64 generates a response signal containing information on the reception intensity of the first measurement signal and information on the reception intensity of the second measurement signal. Here, the information on the reception intensity of the first measurement signal and the information on the reception intensity of the second measurement signal may be a measured reception intensity of the first measurement signal and a measured reception intensity of the second measurement signal. Alternatively, they may be the ratio of the measured reception intensity of the second measurement signal with respect to the measured reception intensity of the first measurement signal. In this case, the information is indicated, for example, as “50%.” The information included in the response signal may also be encrypted. The response signal generated by portable device signal generator 64 is a baseband signal. Portable device signal generator 64 outputs the response signal to UHF transmitter 56.

UHF transmitter 56 receives the response signal from portable device signal generator 64. UHF transmitter 56 modulates the response signal to generate a UHF response signal (hereinafter, this is also called a “response signal”). UHF transmitter 56 sends the response signal to vehicle-mounted device 10 via an antenna. In (c) of FIG. 4, the UHF signal sent from UHF transmitter 56 of portable device 12 is illustrated. The response signal is sent after receiving the second measurement signal in portable device 12.

In (d) of FIG. 5, the response signal sent from UHF transmitter 56 of portable device 12 is illustrated. Here, as an example, the ratio of the measured reception intensity of the second measurement signal with respect to the measured reception intensity of the first measurement signal is “50%.” Description continues with reference to FIG. 3 again. A transmission rate of UHF signal is, for example, 7.8 kbps. A transmission rate of LF signal is, for example, 4 kbps. Accordingly, the transmission rate in UHF transmitter 56 and UHF receiver 34 is higher than a transmission rate in LF receiver 50 and LF transmitter 32.

UHF receiver 34 of vehicle-mounted device 10 receives the response signal from portable device 12. UHF receiver 34 demodulates the received response signal to generate a response signal of the baseband signal (hereinafter this is also called a “response signal). UHF receiver 34 outputs the response signal to vehicle-mounted device controller 30. In (d) of FIG. 4, processing of the received UHF signal in UHF receiver 34 of vehicle-mounted device 10 is illustrated. As illustrated, the response signal is received. Description below continues with reference to FIG. 3 again.

Vehicle-mounted device determiner 40 of vehicle-mounted device controller 30 receives the response signal from UHF receiver 34. Vehicle-mounted device determiner 40 extracts, from the response signal, information on the reception intensity of the first measurement signal and information on the reception intensity of the second measurement signal. Vehicle-mounted device determiner 40 derives a relation between the information on the reception intensity of the first measurement signal and the information on the reception intensity of the second measurement signal (hereinafter referred to as “reception intensity relation”). The reception intensity relation is indicated by the ratio of the reception intensity of the second measurement signal with respect to the reception intensity of the first measurement signal. Accordingly, this derivation step is omitted when the information on the reception intensity of the first measurement signal and the information on the reception intensity of the second measurement signal are indicated by the ratio of the measured value of the reception intensity of the second measurement signal to the measured value of the reception intensity of the first measurement signal.

On the other hand, vehicle-mounted device determiner 40 receives the transmission intensity of the first measurement signal and the transmission intensity of the second measurement signal from vehicle-mounted device controller 30. Vehicle-mounted device determiner 40 derives the ratio of the transmission intensity of the second measurement signal with respect to the transmission intensity of the first measurement signal to derive a relation between the transmission intensity of the first measurement signal and the transmission intensity of the second measurement signal (hereinafter referred to as “transmission intensity relation”). Still more, vehicle-mounted device determiner 40 compares the reception intensity relation and the transmission intensity relation. More specifically, when a difference between the reception intensity relation and the transmission intensity relation is smaller than a threshold, vehicle-mounted device determiner 40 determines that the transmission intensity relation and the reception intensity relation have correlation. When the difference is not less than the threshold, the vehicle-mounted device determiner 40 determines that they have no correlation. When they are determined to have no correlation, this state is regarded as a relay attack. When they have correlation, no relay attack is carried out. In other words, the determination is made on the presence of relay attack on portable device 12.

When they are determined to have correlation, vehicle-mounted device determiner 40 gives instruction to ECU 16 of vehicle 110 to release door-lock mechanism 18. ECU 16 and door-lock mechanism 18 adopt a known technology, and thus their description is omitted here.

In the above description, vehicle-mounted device 10 continuously sends the first measurement signal and the second measurement signal, and portable device 12 sends the response signal. The response signal contains the information on the reception intensity of the first measurement signal and the information on the reception intensity of the second measurement signal. Alternatively, the first measurement signal and the second measurement signal may be sent separately timewise, and a first response signal and a second response signal may be sent in response to the respective measurement signals. Processing in this case is described below.

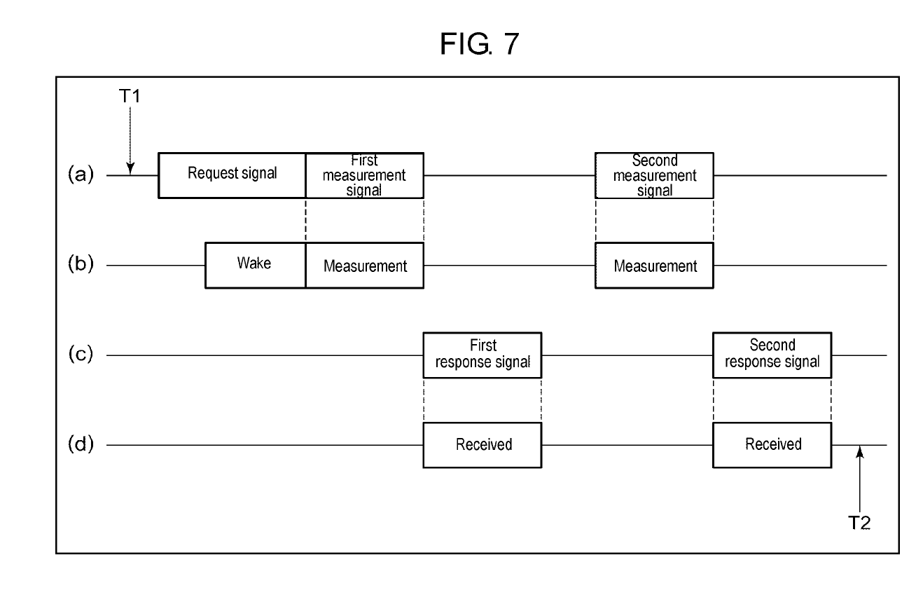

FIG. 7 is still another chart showing signals used in vehicle wireless communication system 100. This is indicated in the same way as FIG. 4. As shown in (a) of FIG. 7, vehicle-mounted device 10 sends a request signal and a first measurement signal successively. As shown in (b) of FIG. 7, portable device 12 wakes up upon receiving the request signal, and measures a reception intensity of the first measurement signal. As shown in (c) of FIG. 7, portable device 12 sends a first response signal containing information on the reception intensity of the first measurement signal. As shown in (d) of FIG. 7, vehicle-mounted device 10 receives the first response signal.

Subsequently, as shown in (a) of FIG. 7, vehicle-mounted device 10 sends the second measurement signal. As shown in (b) of FIG. 7, portable device 12 measures a reception intensity of the second measurement signal. As shown in (c) of FIG. 7, portable device 12 sends a second response signal containing information on the reception intensity of the second measurement signal, and vehicle-mounted device 10 receives the second response signal, as shown in (d) of FIG. 7.

This configuration can be achieved with hardware by any computer CPU, memory, and other LSIs. With respect to software, it can be achieved by a program loaded to the memory. Here, functional blocks achieved by linking these are described. Accordingly, it is apparent that a person having ordinary skill in the art can understand that these functional blocks can be achieved in many ways, including only by hardware and a combination of hardware and software.

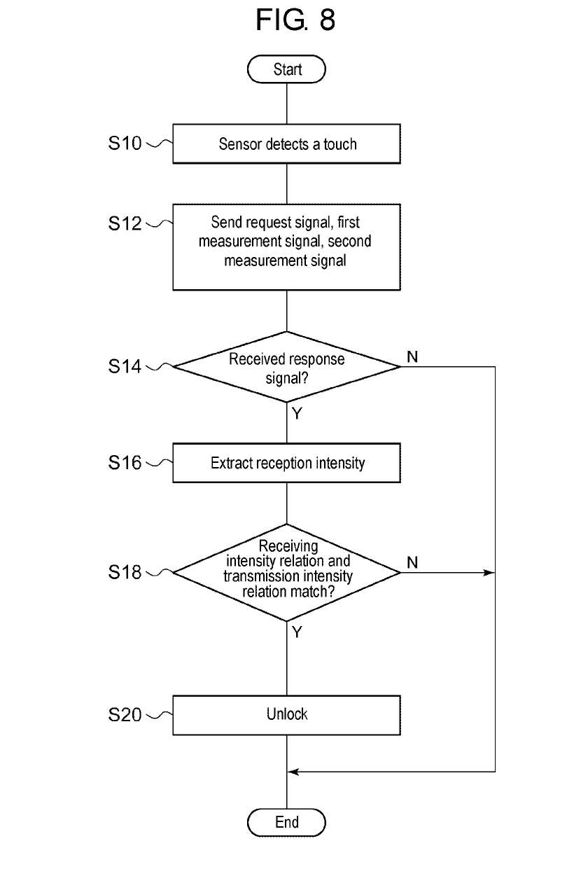

The operation of vehicle wireless communication system 100 as configured above is described. FIG. 8 is a flow chart illustrating communication procedures by vehicle-mounted device 10. Sensor 14 detects a touch (810). LF transmitter 32 sends the request signal, first measurement signal, and second measurement signal (812). When UHF receiver 34 receives the response signal (Y in S14), vehicle-mounted device determiner 40 extracts the reception intensity (816). When the reception intensity relation and the transmission intensity relation correspond to each other (Y in S18), ECU 16 releases door lock mechanism 18 (S20). When UHF receiver 34 does not receive the response signal (N in 814), or the reception intensity relation and the transmission intensity relation do not match (N in 818), processing ends.

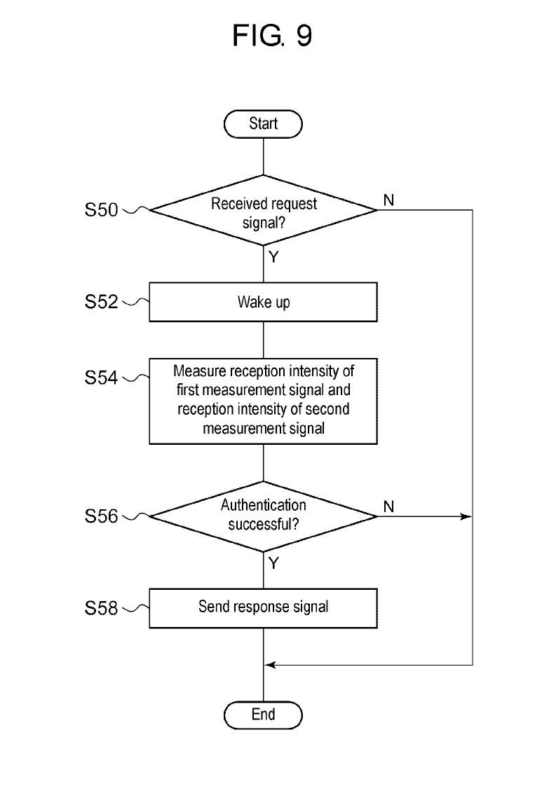

FIG. 9 is a flow chart illustrating communication procedures by portable device 12. When LF receiver 50 receives the request signal (Y in 850), portable device controller 54 wakes up (852). Measurement unit 52 measures the reception intensity of the first measurement signal and the reception intensity of the second measurement signal (854). When authentication by portable device determiner 62 is successful (Y in S56), UHF transmitter 56 sends the response signal (S58). When LF receiver 50 does not receive the request signal (N in 850) or when authentication is not successful (N in S56), processing ends.

According to the exemplary embodiment of the present disclosure, setting of transmission intensity is not sent from the vehicle-mounted device. The setting is only used in internal processing of the vehicle-mounted device. Thus, the setting is hardly reproducible. In addition, as the reception intensities are utilized, the condition for authentication is hardly reproducible. Low reproducibility can reduce a risk of relay attack. Still more, since a transmission rate of signals from the portable device to the vehicle-mounted device is higher than the reverse transmission, information on the reception intensities can be easily added to the response signal. Still more, transmission of the response signal in two parts can increase the flexibility of configuration. Furthermore, since the portable device has no information on the setting of the transmission intensities, a risk of relay attack can be reduced.

An outline of one aspect of the present disclosure is described below. The vehicle-mount device in one aspect of the present disclosure includes a transmitter and a receiver. The transmitter sends a request signal, a first measurement signal, and a second measurement signal to the portable device. The receiver receives a response signal containing information on a reception intensity of the first measurement signal and a reception intensity of the second measurement signal from the portable device which has received the request signal, the first measurement signal, and the second measurement signal sent from the transmitter. The transmitter sends the second measurement signal with a transmission intensity different from a transmission intensity of the first measurement signal, and the vehicle-mounted device authenticates the portable device based on a relation between the information on the reception intensity of the first measurement signal and the information on the reception intensity of the second measurement signal contained in the response signal received by the receiver and a relation between the transmission intensity of the first measurement signal and the transmission intensity of the second measurement signal sent from the transmitter.

According to the aspect, the setting of the transmission intensities is not sent from the vehicle-mounted device, and thus a risk of relay attack can be reduced.

The transmission rate of the receiver may be higher than the transmission rate of the transmitter. In this case, the signal from the portable device to the vehicle-mounted device is faster, and thus information volume contained in the signal in this direction can be easily increased.

The response signal received by the receiver may also be configured with the first response signal containing the information on the reception intensity of the first measurement signal and the second response signal containing the information on the reception intensity of the second measurement signal. In this case, transmission of the response signals in two parts can increase flexibility of the configuration.

Another aspect of the present disclosure is a portable device. This portable device includes a receiver, a measurement unit, and a transmitter. The receiver receives a request signal, a first measurement signal, and a second measurement signal from a vehicle-mounted device. The measurement unit measures a reception intensity of the first measurement signal and a reception intensity of the second measurement signal when the receiver receives the request signal, the first measurement signal, and the second measurement signal. The transmitter sends, to the vehicle-mounted device, a response signal containing information on the reception intensity of the first measurement signal and information on the reception intensity of the second measurement signal. Both of the reception intensities are measured by the measurement unit. The second measurement signal received by the receiver is sent from the vehicle-mounted device using a transmission intensity different from a transmission intensity of the first measurement signal. The portable device is authenticated by the vehicle-mounted device based on a relation between the information on the reception intensity of the first measurement signal and the information on the reception intensity of the second measurement signal contained in the response signal sent from the transmitter and a relation between the transmission intensity of the first measurement signal and the transmission intensity of the second measurement signal received by the receiver.

According to the aspect, the setting of the transmission intensities is not informed from the vehicle-mounted device, and thus a risk of relay attack can be reduced.

A transmission rate in the transmitter may be higher than a transmission rate in the receiver. In this case, a signal from the portable device to the vehicle-mounted device is faster, and thus information volume contained in the signal in this direction can be easily increased.

The response signal sent from the transmitter may be configured with a first response signal containing the information on the reception intensity of the first measurement signal and the second response signal containing the information on the reception intensity of the second measurement signal. In this case, the response signals sent in two parts can increase flexibility of the configuration.

Still another aspect of the present disclosure is a vehicle wireless communication system. The vehicle wireless communication system includes a vehicle-mounted device and a portable device. The vehicle-mounted device sends a request signal, a first measurement signal, and a second measurement signal. The portable device measures a reception intensity of the first measurement signal and a reception intensity of the second measurement signal upon receiving the request signal, the first measurement signal, and the second measurement signal from the vehicle-mounted device, and sends, to the vehicle-mounted device, a response signal containing information on the measured reception intensity of the first measurement signal and information on the measured reception intensity of the second measurement signal. The vehicle-mounted device sends, to the portable device, the second measurement signal with a transmission intensity different from the transmission intensity of the first measurement signal. The vehicle-mounted device authenticates the portable device based on a relation between the information on the reception intensity of the first measurement signal and the information on the reception intensity of the second measurement signal contained in the received response signal and a relation between the transmission intensity of the sent first measurement signal and the transmission intensity of the sent second measurement signal.

According to the aspect, the setting of transmission intensity is not sent from the vehicle-mounted device, and thus a risk of relay attack can be reduced.

The present disclosure is described above with reference to the exemplary embodiment. The exemplary embodiment is illustrative and there are various modifications by combining their components or processes. Those skilled in the art would understand that these modifications are also embraced in the scope of the present disclosure.

In the exemplary embodiment, UHF transmitter 56 and UHF receiver 34 use the UHF signal. However, the present disclosure is not limited to the UHF signal. For example, a signal with higher frequency than LF, other than the UHF signal, may be used. The modified embodiment can increase flexibility of the configuration.

The exemplary embodiment describes vehicle wireless communication system 100 as a countermeasure for relay attack on door-lock release. However, the present disclosure is not limited to door-lock release. For example, vehicle wireless communication system 100 against relay attacks may be applicable to the engine start operation of a vehicle employing the keyless entry system. The modified embodiment can reduce a risk of relay attack also in the engine start operation of vehicles.

The present disclosure is applicable to vehicle-mounted devices, portable devices, and vehicle wireless communication systems.

What is claimed is:

1. A vehicle-mounted device comprising:
a transmitter configured to send a request signal, a first measurement signal, and a second measurement signal to a portable device; and
a receiver configured to receive a response signal from the portable device having received the request signal, the first measurement signal, and the second measurement signal sent from the transmitter, the response signal containing information on a reception intensity of the first measurement signal and information on a reception intensity of the second measurement signal,
wherein the transmitter sends to the portable device the second measurement signal with a transmission intensity different from a transmission intensity of the first measurement signal, and
the vehicle-mounted device authenticates the portable device based on a relation between the information on the reception intensity of the first measurement signal and the information on the reception intensity of the second measurement signal contained in the response signal received by the receiver and a relation between the transmission intensity of the first measurement signal and the transmission intensity of the second measurement signal sent from the transmitter.

2. The vehicle-mounted device of claim 1,
wherein a transmission rate of the receiver is higher than a transmission rate of the transmitter.

3. The vehicle-mounted device of claim 1,
wherein the response signal received by the receiver is configured with a first response signal containing the information on the reception intensity of the first measurement and a second response signal containing the information on the reception intensity of the second measurement signal.

4. A portable device comprising:
a receiver configured to receive a request signal, a first measurement signal, and a second measurement signal from a vehicle-mounted device;
a measurement unit configured to measure a reception intensity of the first measurement signal and a reception intensity of the second measurement signal when the receiver receives the request signal, the first measurement signal, and the second measurement signal; and
a transmitter configured to send, to the vehicle-mounted device, a response signal containing information on the reception intensity of the first measurement signal measured by the measurement unit and information on the reception intensity of the second measurement signal, both of the reception intensities being measured by the measurement unit,
wherein the second measurement signal received by the receiver is sent from the vehicle-mounted device with a transmission intensity different from a transmission intensity of the first measurement signal, and
the portable device is authenticated by the vehicle-mounted device based on a relation between the information on the reception intensity of the first measurement signal and the information on the reception intensity of the second measurement signal contained in the response signal sent from the transmitter and a relation between the transmission intensity of the first measurement signal and the transmission intensity of the second measurement signal received by the receiver.

5. The portable device of claim 4,
wherein a transmission rate of the transmitter is higher than a transmission rate of the receiver.

6. The portable device of claim 4,
wherein the response signal sent from the transmitter is configured with a first response signal containing the information on the reception intensity of the first measurement signal and a second response signal containing the information on the reception intensity of the second measurement signal.

7. A vehicle wireless communication system comprising:
a vehicle-mounted device configured to send a request signal, a first measurement signal, and a second measurement signal; and
a portable device configured to measure a reception intensity of the first measurement signal and a reception intensity of the second measurement signal upon receiving the request signal, the first measurement signal, and the second measurement signal from the vehicle-mounted device, and send, to the vehicle-mounted device, a response signal containing information on the measured reception intensity of the first measurement signal and information on the measured reception intensity of the second measurement signal,
wherein the vehicle-mounted device sends, to the portable device, the second measurement signal with a transmission intensity different from a transmission intensity of the first measurement signal, and
the vehicle-mounted device authenticates the portable device based on a relation between the information on the reception intensity of the first measurement signal and the information on the reception intensity of the second measurement signal contained in the received response signal and a relation between the transmission intensity of the sent first measurement signal and the transmission intensity of the sent second measurement signal.
